(19) United States
(12) Patent Application Publication
(10) Pub. No.: US 2011/0246825 A1
(43) Pub. Date: Oct. 6, 2011

(54) IMAGE FORMING APPARATUS AND DATA TRANSFER METHOD

(75) Inventor: Shinji Koizumi, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/042,557

(22) Filed: Mar. 8, 2011

Related U.S. Application Data
(60) Provisional application No. 61/318,861, filed on Mar. 30, 2010.

(51) Int. Cl. G06F 11/14

(52) U.S. Cl. 714/18; 714/E11.117

(57) ABSTRACT

An image forming apparatus includes a storage part, an error detection part, a connection detection part, a determination part and a data transfer part. The storage part stores data. The error detection part detects whether data transfer between the storage part and an external storage device failed. The connection detection part detect whether an external storage device is connected. The determination part determines whether the external storage device whose connection is detected by the connection detection part is coincident with the external storage device which failed in the data transmission. When the determination part determines the coincidence, the data transfer part transfers the transfer failed data between the storage part and the external storage device whose connection is detected by the connection detection part.

### CROSS-REFERENCE TO RELATED APPLICATION

This application is also based upon and claims the benefit of priority from U.S. provisional application 61/318,861, filed on Mar. 30, 2010; the entire contents of which are incorporated herein by reference.

### FIELD

Embodiments described herein relate generally to a data transfer technique to an external storage device.

### BACKGROUND

It is usually performed that electronic data, such as document data or image data, is stored in an external storage device, such as a USB (Universal Serial Bus) memory or an SD card (SD Memory Card), which is supposed to be detached and attached, and the data is moved between equipments.

Besides, a technique to directly copy (transfer) an image scanned by an image forming apparatus to an external storage device is known.

When connection between an equipment and an external storage device is disconnected through user's carelessness during file writing, or when the storage capacity of the external storage device is insufficient, a file being written does not exist or the written file is damaged. In this case, the user is required to again connect the external storage device to the equipment and to execute a writing instruction.

### BRIEF DESCRIPTION OF THE DRAWINGS

FIG. 1 is a view showing a see-through view of an image forming apparatus of an embodiment.

FIG. 2 is a view showing a hardware structural example of a control board of the embodiment.

FIG. 3 is a block diagram showing a structural example of the image forming apparatus of the embodiment.

FIG. 4 is a view showing an example of a table stored in a storage part of the embodiment.

FIG. 5A is a flowchart (ACT 1 to ACT 9) showing an operation example of the image forming apparatus of the embodiment.

FIG. 5B is a flowchart (ACT 10 to ACT 17) showing the operation example of the image forming apparatus of the embodiment.

### DETAILED DESCRIPTION

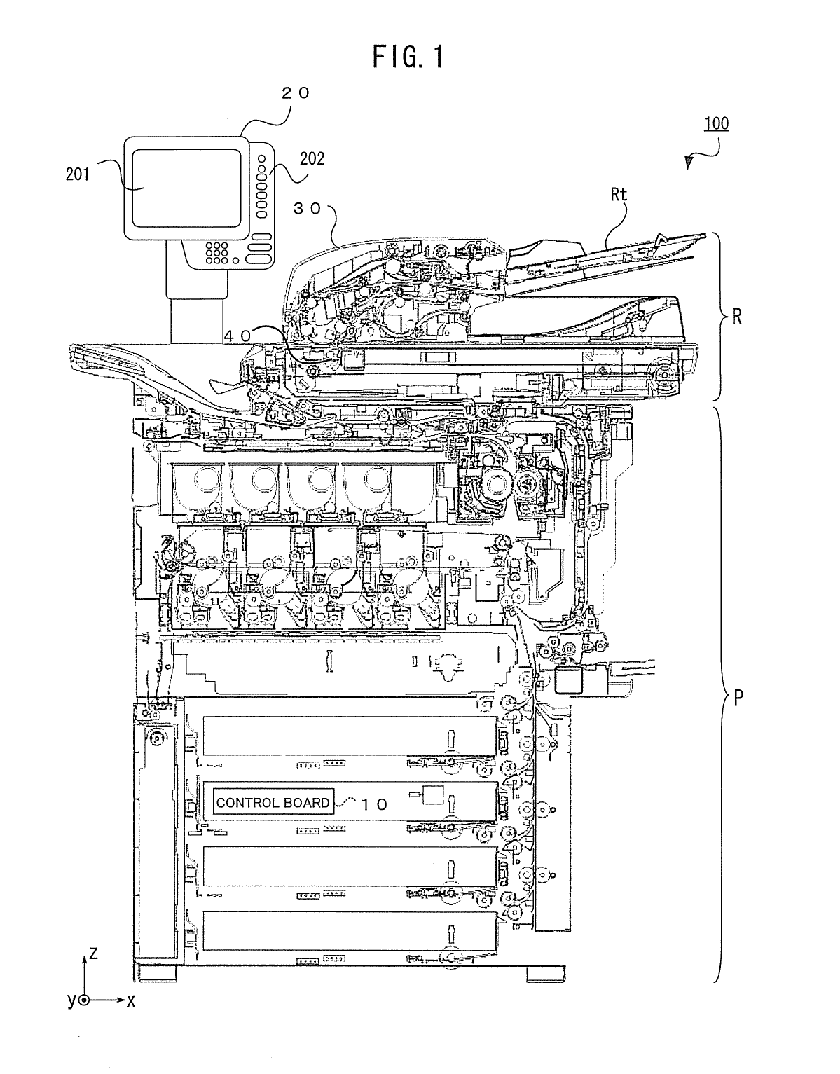

Hereinafter, an embodiment will be described with reference to the drawings. FIG. 1 is a see-through view showing a schematic structure of an image forming apparatus of an embodiment. As shown in FIG. 1, the image forming apparatus 100 includes an image reading part R and an image forming part P.

The image reading part R scans and reads an image of a sheet document and a book document. The image reading part R includes an auto document feeder (ADF) to automatically feed a document to a specified image reading position. A scan optical system 40 reads an image of a document automatically fed by the auto document feeder 30 and placed on a document tray Rt or an image of a document placed on a not-shown document table.

The image forming part P forms a developer image on a sheet based on the image read from the document by the image reading part R or image data transmitted from an external equipment to the image forming apparatus 100. Besides, the image forming part P includes a control board 10 to overall control the respective part of the image forming apparatus 100.

Besides, the image forming apparatus 100 includes a control panel 20 to receive execution instructions of respective processes, such as copying, scanning and fax transmission, from the user and set values of the respective processes, such as the number of processed sheets and transmission destination. The control panel 20 may be a touch panel display 201 or a keyboard 202.

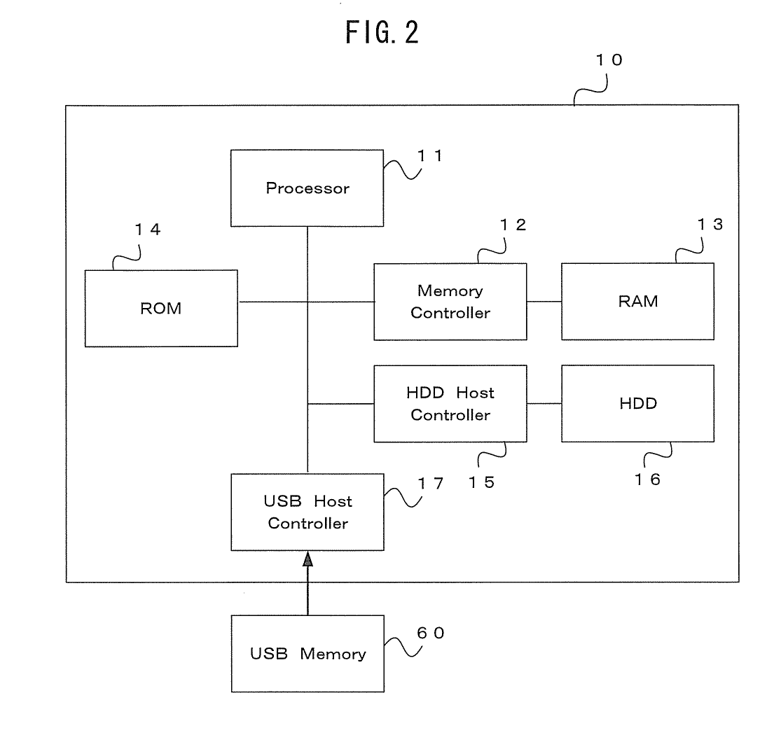

FIG. 2 is a view showing a hardware structural example of the control board 10. A processor 11 to perform numerical calculation and equipment control is connected to a ROM (Read Only Memory) 14 as a flash memory, a memory controller 12, a HDD (Hard Disk Drive) host controller 15, and a USB host controller 17. The ROM 14 previously stores a program to be operated by the processor 11. The memory controller 12 is connected to a RAM (Random Access Memory) 13 as a volatile main storage device, and performs an input and output control to the RAM 13, and a refresh control to the RAM 13. The HDD host controller 15 is connected to a HDD 16 as a nonvolatile storage device, and performs an access control to the HDD 16. The USB host controller 17 controls data input and output from and to an equipment based on USB standard. The USB controller 17 includes a connection terminal based on USB standard, and respective equipments are connected and disconnected through the connection terminal. In this embodiment, a description will be made on the assumption that a USB memory (a USB 60 in the example of FIG. 2) is connected and disconnected. Incidentally, the respective storage devices of the RAM 13 and the ROM 14 are sufficient, the HDD host controller 15 and the HDD 16 may be omitted.

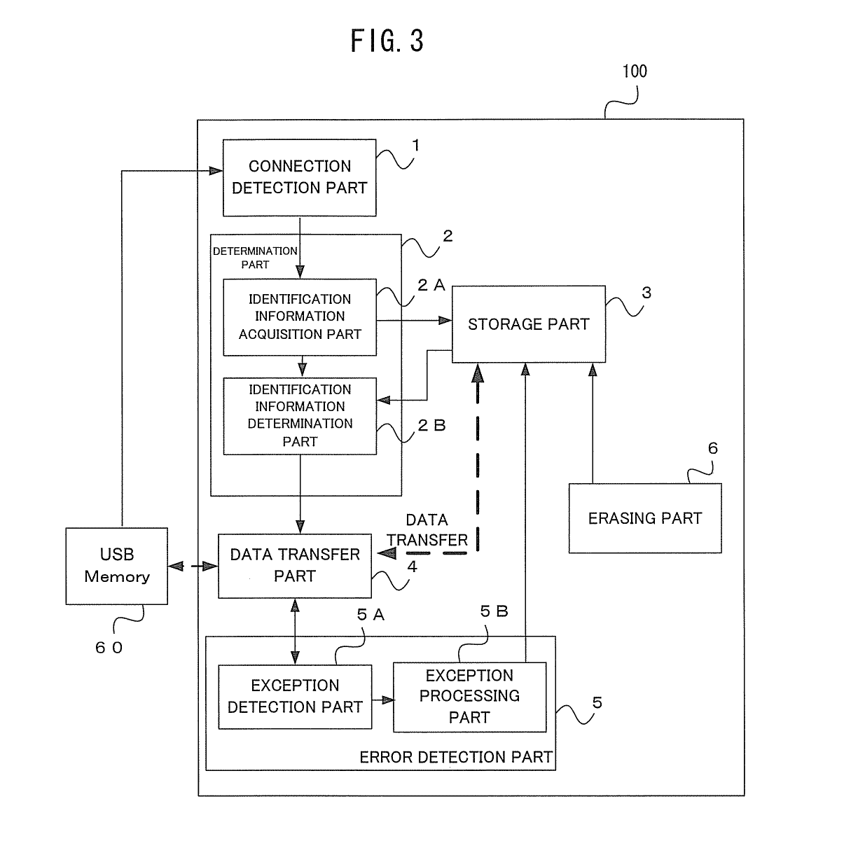

A block diagram of FIG. 3 shows an example of a structure to realize the embodiment. The image forming apparatus 100 includes a connection detection part 1, a determination part 2, a storage part 3, a data transfer part 4, an error detection part 5 and an erasing part 6.

The connection detection part 1 detects the presence or absence of connection of an external storage device. In this embodiment, the USB memory is the external storage device, and the connection detection part 1 detects the rising (signal level becomes an H level from an L level) of one of a D+ signal and a D− signal in the USB connection and detects the connection of the USB equipment.

The determination part 2 is a unit to determine whether the USB memory whose connection is detected by the connection detection part 1 is the USB memory which failed in data transfer, and includes an identification information acquisition part 2A and an identification information determination part 2B. The identification information acquisition part 2A acquires the identification information of the USB memory, whose connection is detected by the connection detection part 1, from the USB memory. In this embodiment, the description is made on the assumption that the serial information, vender information and product ID of the USB memory are used as the identification information, and these pieces of information are combined to identify the USB memory. However, any information, such as volume label or identification ID, may be used as long as the respective devices can be identified. The identification information determination part 2B determines whether the identification information acquired by the identification information acquisition part 2A is coincident with the identification information stored in the storage part 3 by the error detection part 5.

The storage part 3 is a unit to store set values and various data generated on the respective processes. The storage part 3 stores at least a file whose data transmission failed and a table (described later) in which the file whose data transfer failed and the identification information of the USB memory are correlated with each other.

The data transmission part 4 is a unit to transfer data between the storage part 3 and the USE memory 60. Besides, when the identification information determination part 2B determines that the pieces of identification information are coincident, the data transfer part 4 refers to the table in the storage part 3 to specify the file whose transmission failed, and retransmits the file. Besides, the data transfer part 4 refers to the table and determines whether data transfer is writing from the USE memory 60 to the storage part 3 or writing from the storage part 3 to the USB memory 60.

The error detection part 5 is a unit to detect whether data transfer between the storage part 3 and the USB memory 60 failed, and includes an exception detection part 5A and an exception processing part 5B. The exception detection part 5A detects whether data transfer failed by detecting disconnection between the image forming apparatus 100 and the USB memory 60 (detecting whether both the D+ signal and D-signal of the USB connection terminal become the L level) or determining whether transfer is made until the end of transfer object data. When the exception detection part 5A detects the failure of the transfer, the exception processing part 5B stores the data whose transfer failed into the nonvolatile area of the storage part 3, correlates at least the identification information of the USB memory 60 with the data whose transfer failed, and stores them into the nonvolatile area of the storage part 3.

The erasing part 6 erases the identification information and the transfer failed data, which are continuously stored in the storage part 3 for a specific period, from the storage part 3.

The software control of the respective blocks shown in FIG. 3 is realized in such a manner that respective programs stored in the ROM 14 are loaded to the RAM 13, and the processor 11 executes the loaded programs. In the light of this point, the correspondence between the hardware structure of FIG. 2 and the block diagram of FIG. 3 will be described. The connection detection part 1 is realized by the processor 11, a program in the ROM 14 and the USB host controller 17. The identification information acquisition part 2A is realized by the processor 11, a program in the ROM 14, the USB host controller 17 and the memory controller 12.

The identification information determination part 2B is realized by the processor 11, a program in the ROM 14, the memory controller 12 and the HDD host controller 15. The storage part 3 is realized by the RAM 13 and the HDD 16. The data transfer part 4 is realized by the processor 11, a program in the ROM 14, the memory controller 12, the HDD host controller 15 and the USB host controller 17.

The exception detection part 5A is realized by the processor 11, a program in the ROM 14, the memory controller 12, the HDD host controller 15 and the USB host controller 17. The exception processing part 5B is realized by the processor 11, a program in the ROM 14 and the HDD host controller 15. The erasing part 6 is realized by the processor 11, a program in the ROM 14 and the HDD host controller 15. Incidentally, the respective control units of the memory controller 12 and the HDD host controller 15 may be arranged at the side of the storage part 3.

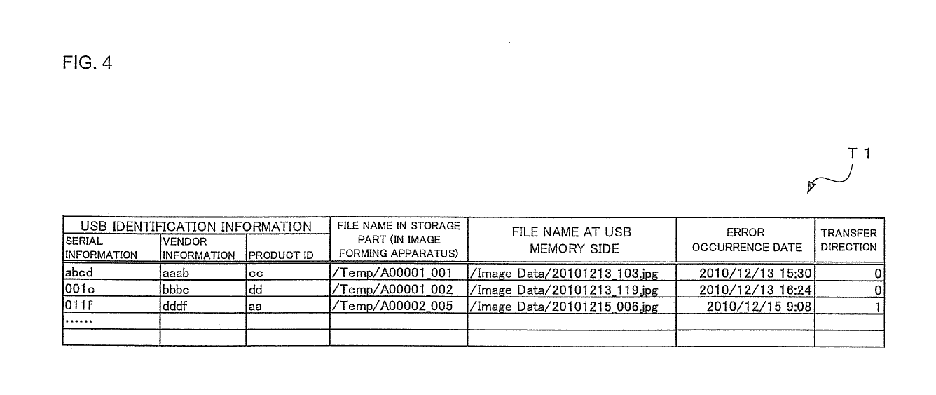

FIG. 4 shows an example of the table stored in the storage part 3. The exception processing part 5B registers the respective records of the table T1, and when retransmission is performed, the data transfer part 4 (which may be the erasing part 6) erases the relevant record. Besides, the erasing part 6 erases a record in the table T1, for which a specified period passes.

As shown in FIG. 4, in the table T1, the respective pieces of identification information of the serial information, vender information and product ID of the USB memory 60, and the respective pieces of information of the file name (full path notation) in the storage part 3, file name (full path notation) at the USB memory side, and the error occurrence date are correlated with each other and are stored. Besides, the transfer direction is also correlated, and in this embodiment, the case of data transfer from the storage part 3 to the USB memory is “0”, and the data transfer from the USB memory to the storage part 3 is “1”. Incidentally, in this embodiment, the image forming apparatus 100 determines so that the respective values of the file name in the storage part 3 and the file name at the USB memory side become unique. However, the user may determine the respective values through the control panel 20. Besides, in this embodiment, although the information of the error occurrence date is written, the information of transfer start date is acquired and may be written.

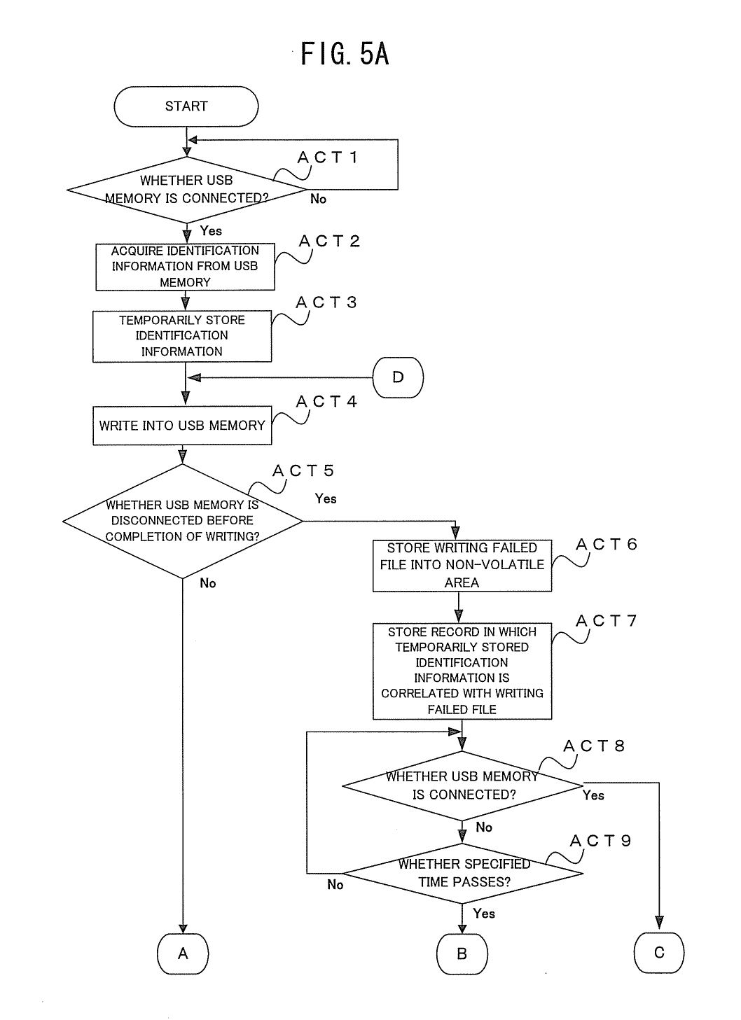

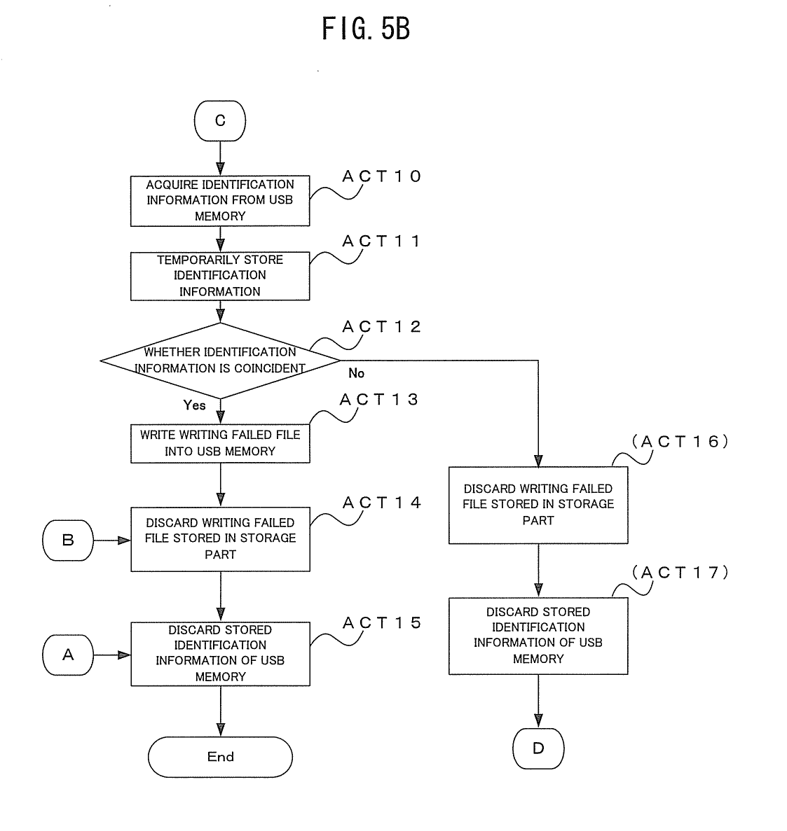

Next, an operation example of the image forming apparatus 100 will be described with reference to FIG. 5A and FIG. 5B. In the following description, the description relates to the case where image data read by the image reading part R is directly transferred to the USE memory 60, and the description is made on the case, as an example, where the USB memory 60 is disconnected by the user during the data transfer.

First, after a document is converted into electronic image data by the image reading part R, the electronic image data is temporarily stored in the buffer area of the storage part 3.

Thereafter, when the user sets the USB memory 60 to the connection terminal of the USE host controller 17, the connection detection part 1 detects that the USB memory is connected (ACT 1, Yes). The identification information acquisition part 2A acquires the identification information of the USE memory 60 from the connected USB memory 60. The identification information acquired here is temporarily stored in the buffer area of the storage part 3 (ACT 3).

Here, the identification information determination part 2B once performs a determination process (see ACT 12 with respect to the details of the process). Thereafter, the data transfer part 4 starts a process of writing the electronic image data temporarily stored in the buffer area into the USB memory 60 (ACT 4). The exception detection part 5A monitors whether disconnection (the USB memory 60 is pulled out from the image forming apparatus 100 during writing) of the USB memory 60 by the user is performed (ACT 5).

When the writing process is normally completed (ACT 5, No), the identification information temporarily stored in ACT 3 is discarded (ACT 15), and the process is ended. On the other hand, when the USB memory 60 is disconnected before the writing of the file is completed (ACT 5, Yes), the exception processing part 5B gives a unique file name to the electronic image data whose writing failed, and stores the electronic image data into a nonvolatile folder (/Temp folder in this embodiment) of the storage part 3 (ACT 6). The exception processing part 5B correlates the identification information temporarily stored in ACT 3, the file name of the writing failed file in the storage part 3, the file name at the USB memory side, the error occurrence date and the data transfer direction, and registers them as a new record into the table T1 (ACT 7). Incidentally, a message indicating that the writing failed may be displayed on the control panel 20.

Until here, the description is made on the case where writing to the USB memory failed. Next, retransmission of data will be described.

The connection detection part 1 continuously detects whether a USB memory is connected to the image forming apparatus 100 (ACT 8). The erasing part 6 continuously determines whether the storage period of each record passes a specified period (ACT 9). The specified period may be a fixed period embedded in the program or a period set by the user in advance. The erasing part 6 acquires an error occurrence date column of each record in the table T1, and determines whether the difference between the error occurrence date and the present date exceeds the specified period for each record. When there is a record in which the specified period passed (ACT 9, Yes), the writing failed file stored in the image forming apparatus 100 is discarded based on the file name (file name in the storage part 3) registered in the record (ACT 14), and the identification information (that is, the relevant record in the table T1) is discarded (ACT 15). Although the process is ended in the flowchart of FIG. 5B, return may be made to the process of ACT 8. Besides, the process of the erasing part may be periodically performed (the process becomes asynchronous with the other process).

When the connection detection part 1 detects the connection of the USB memory in ACT 8 (ACT 8, Yes), the identification information acquisition part 2A acquires the identification information of the connected USB memory 60 from the USB memory 60 (ACT 10), and temporarily stores the acquired identification information into the buffer area of the storage part 3 (ACT 11). Next, the identification information determination part 2B determines whether the acquired identification information exists in the table T1 (ACT 12). When the coincident identification information exists in the table T1 (ACT 12, Yes), the data transfer part 4 acquires the relevant record from the table T1, extracts the respective pieces of information of the file name in the storage part 3, the file name at the USB memory side and the transfer direction, and retransmits the file whose writing failed (ACT 13). Incidentally, before ACT 13, a message indicating that retransmission is performed is displayed on the control panel 20, and an execution instruction of retransmission from the user may be received.

When the same USB memory is reconnected, the file whose writing failed is retransmitted by the process of ACT 8 to ACT 13.

Thereafter, the data transfer part 4 (which may be the erasing part 6) discards the writing failed file whose transfer is completed (ACT 14), and discards the relevant record from the table T1 (ACT 15).

Incidentally, when it is determined in ACT 12 that the identification information of the presently connected USB memory 60 does not exist in the record T1 (ACT 12, No), the process proceeds to ACT 4 (see character “D” in FIG. 5B). However, when the storage part 3 stores only one record or one file, ACT 16 and ACT 17 are executed. That is, the writing failed file stored in the storage part 3 is discarded (ACT 16), and the record is erased (ACT 17).

In the foregoing operation example, although the description is made on the example of data writing from the storage part 3 to the USB memory, since the respective file names of data transmission source and transmission destination are registered in the table T1, and the transfer direction is also correlated and registered, data writing from the USB memory 60 to the storage part 3 is also allowed. Besides, in the operation example, although the description is made on the case, as an example, where the USB memory 60 is disconnected during data transfer, the exception detection part 5 determines whether data transfer is normally completed to the end of the object data, and detects also an error due to insufficient capacity of the USB memory 60 or due to medium defect

In this embodiment, although the data transfer of the image forming apparatus is described, the mode is not limited, and any equipment may be used as long as the equipment includes a storage part capable of storing data, and can be connected to an external storage device. As an example of the equipment as stated above, a computer such as a PC (Personal Computer) or a server is conceivable. Besides, the connection to the external storage device includes a connection through a wired or wireless network (LAN etc.).

According to the embodiment, for example, when the external storage device is disconnected through user's carelessness, or writing failure due to insufficient capacity of the external storage device or writing failure due to defect of a medium of the external storage device occurs, when the same external storage device is connected, the failed file is automatically transferred without user's execution of specified operation for performing retransmission. Thus, the burden of the user is reduced, and the convenience for the user is improved.

Although the case where the program for executing the process of this embodiment is previously recorded in the storage area provided in the image forming apparatus 100 is exemplified, the program may be downloaded from a network to the image forming apparatus 100, or a computer readable recording medium storing the program may be installed in the image forming apparatus 100. As the recording medium, any form may be adopted as long as the recording medium can store the program and can be read by a computer. As the recording medium, for example, an internal storage device installed in a computer, such as a ROM or a RAM, a portable storage medium such as a CD-ROM, a flexible disk, a DVD disk, a magneto-optical disk or an IC card, a database to store a computer program, or another computer and its database, a transmission medium on a line and the like are enumerated. The function obtained by installation or download in advance may realize the function in cooperation with an OS (Operating System) in the apparatus. At least a part of the process realized by causing a CPU or an MPU to execute the program may be executed by a circuit using an ASIC.

The invention can be carried out in various modes without departing from the spirit or the main features thereof. Thus, the foregoing embodiment is merely an example in all respects, and should not be interpreted as limitation. The scope of the invention is described in the claims, and is not limited by the specification. Further, all modifications, various improvements, substitutions and alterations belonging to the equivalent range of the claims are included within the scope of the invention.

What is claimed is:

1. An image forming apparatus comprising:
a storage part to store data;
an error detection part to detect whether data transfer between the storage part and an external storage device failed;
a connection detection part to detect presence or absence of connection of an external storage device;
a determination part to determine whether the external storage device whose connection is detected by the connection detection part is coincident with the external storage device which failed in the data transmission; and
a data transfer part to transfer, when the determination part determines coincidence, the transfer failed data between the storage part and the external storage device whose connection is detected by the connection detection part.

2. The apparatus of claim 1, wherein
when detecting that the transfer failed, the error detection part correlates identification information of the external storage device in a connection state when the transfer failed with the transfer failed data and stores them into the storage part, and
the determination part acquires identification information of the external storage device whose connection is detected by the connection detection part from the external storage part, determines whether the acquired identification information is coincident with the identification information stored in the storage part by the error detection part, and determines whether the external storage device whose connection is detected by the connection detection part is coincident with the external storage device which failed in the data transfer.

3. The apparatus of claim 2, wherein when the determination part determines the coincidence, the data transmission part transfers the data corresponding to the identification information stored in the storage part.

4. The apparatus of claim 2, further comprising an erasing part to erase identification information and data, which are stored in the storage part continuously for a specific period, from the storage part.

5. The apparatus of claim 4, wherein
the error detection part correlates error occurrence date information with the identification information of the external storage device and the transfer failed data and stores them into the storage part, and
when a difference between present date and the error occurrence date information stored in the storage part exceeds the specified period, the erasing part erases the identification information corresponding to the date information and the corresponding data.

6. The apparatus of claim 1, further comprising an image reading part to scan a document, wherein
the data transferred between the storage part and the external storage device is image data scanned by the image reading part.

7. The apparatus of claim 1, wherein the external storage device is a storage device which can be hot swapped.

8. The apparatus of claim 7, wherein the error detection part detects disconnection between the storage device, which can be hot swapped, and the image forming apparatus and detects whether the data transfer failed.

9. The apparatus of claim 2, wherein the connection between the external storage device and the image forming apparatus is a connection based on USB standard, and the identification information is a combination of serial information, vender information and product ID of the external storage device.

10. The apparatus of claim 2, wherein the identification information is a volume label attached to the external storage device.

11. A data transfer method for performing data transfer between an equipment including a storage part to store data and an external storage device, wherein the equipment
detects whether data transfer between the storage part and an external storage device failed;
detects whether an external storage device is connected;
determines whether the external storage device whose connection is detected is coincident with the external storage device which failed in the data transfer; and
retransfers, when coincidence is determined, the transfer failed data between the storage part and the external storage device whose connection is detected.

12. The method of claim 11, wherein
when the failure of the transfer is detected, identification information of the external storage device connected when the transfer failed is correlated with the transfer failed data and is stored into the storage part, and
identification information of the external storage device whose connection is detected is acquired from the external storage part, it is determined whether the acquired identification information is coincident with the identification information stored in the storage part, and it is determined whether the external storage device whose connection is detected is coincident with the external storage device which failed in the data transfer.

13. The method of claim 12, wherein when the coincidence is determined at the determination of whether the respective pieces of identification information are coincident, data corresponding to the identification information is transferred and the transfer failed data is retransmitted.

14. The method of claim 12, wherein the identification information and the data, which are stored in the storage part continuously for a specific period, are erased from the storage part.

15. The method of claim 11, wherein the equipment is an image forming apparatus, and the data transferred between the storage part and the external storage device is image data scanned from a document by the image forming apparatus.

16. The method of claim 11, wherein
the external storage device is a storage device which can be hot swapped, and
disconnection between the storage device, which can be hot swapped, and the image forming apparatus is detected to detect whether the data transfer failed.

17. An image forming apparatus comprising:
means for storing data;
error detection means for detecting whether data transfer between the storage means and an external storage device failed;
connection detection means for detecting whether an external storage device is connected;
determination means for determining whether the external storage device whose connection is detected by the connection detection means is coincident with the external storage device which failed in the data transmission; and
data transfer means for transferring, when the determination means determines the coincidence, the transfer failed data between the storage means and the external storage device whose connection is detected by the connection detection means.

18. The apparatus of claim 17, further comprising image reading means for scanning a document, wherein
the data transferred between the storage means and the external storage device is image data scanned by the image reading means.

19. The apparatus of claim 17, wherein the external storage device is a storage device which can be hot swapped.

20. The apparatus of claim 19, wherein the error detection means detects disconnection between the storage device, which can be hot swapped, and the image forming apparatus and detects whether the data transfer failed.
